(19) United States
(12) Patent Application Publication
(10) Pub. No.: US 2004/0179058 A1
(43) Pub. Date: Sep. 16, 2004

(54) Method and apparatus for forming a liquid coating on one surface of a substrate

(75) Inventor: Ira M. Harris, New York, NY (US)

Correspondence Address: Ladas & Parry, 26 West 61st Street, New York, NY, 10023, US

(73) Assignee: DAIGE, INC.

(21) Appl. No.: 10/706,499

(22) Filed: Nov. 12, 2003

Related U.S. Application Data
(60) Provisional application No. 60/453,449, filed on Mar. 10, 2003.

(51) Int. Cl. B41J 2/165

(52) U.S. Cl. 347/33

(57) ABSTRACT

Apparatus for applying liquid coating to one side of a flat, flexible medium comprising: a tray for containing a liquid coating, a cover pivotably connected to said tray for being moved between closed and open positions, a fixed wiper member at one end of said tray extending upwardly and outside said cover when the over is in said closed position, said tray being open when said cover is in said open position so that a medium to be coated can be placed on said tray with a first part of the medium extending on and in front of said wiper member, a projecting member on said cover to press the medium into the liquid coating when the cover is in closed position, and a rod extending across said cover for being positioned adjacent to said wiper member to engage the medium therebetween with the front part of the medium extending in front of the wiper member to enable the front part of the medium to be engaged to pull the medium from the tray between the wiper member and the rod and cause a coating of the coating liquid to be applied to a front surface of the medium with a determined thickness while a back surface of the medium is wiped clean by the wiper member.

### FIELD OF THE INVENTION

The invention relates to an apparatus and method for forming a liquid coating on one surface of a substrate and particularly to the forming of a liquid coating of a determined thickness on the one surface of the substrate while the opposite surface is uncoated.

### BACKGROUND

In the digital printing industry, it is known to print artwork, posters, signage and presentations using wide format inkjet printers. These printers can print large banners on various media, such as vinyl, banner material and paper. The images on the media can be affected by UV rays, water and abrasion, and therefore a protective covering is needed.

In this regard, it is known to use water-based clear coatings as a means of protecting the images on the media. The coating is applied to the image side only and, after the coating dries, it provides the necessary protection. The coating must dry to a smooth, even finish.

It has been found difficult to apply water-based coatings manually, especially for larger size sheets, so users are forced to use more expensive automatic coaters. Current application methods include:

(A) Manual Methods

(1) Brushing: brushes are used to apply the coating, but normally the brushes leave brush marks in the final coating. Also this technique is relatively slow when coating large sheets.

(2) Hand rolling:

a roller similar to a paint roller is used. This has the disadvantage that roll marks are produced in the coating which lead to an uneven coating layer.

(3) Spraying:

this process is very messy and can impart particles in the finished coating layer. It is also difficult to obtain a uniform coating thickness over the entire sheet.

(4) Coating Rod (draw down rod):

this technique utilizes a ½″ steel rod that is wound with a thin gauge stainless steel wire. This is a conventional means for applying coatings in labs. In this technique, the coating liquid is poured on the sheet in front of the rod and the rod is pulled down and over the sheet and the coating liquid. The rod spreads the coating out evenly over the sheet. Since the rod is smaller than the width of larger sheets, it is difficult to evenly coat large sheets, as puddles are formed at the side of the rod. Also, it is disadvantageous to pour more coating liquid on the sheet in order to prevent missing areas to be coated.

(B) Automatic Methods

(1) Automatic roller coaters:

these include a wire-wound coating roller immersed in a tray of coating liquid. A top surface of the roller co-acts with a bottom coating roller to feed the media sheet through the rollers by a drive motor. The bottom roller turns, picks up the coating liquid and applies an even coating to the image on the media.

(2) More expensive roll-to-roll coaters are known which employ a wire-wound stationary roller that is flooded, using pumps. The media is automatically pulled over the coating rod and is coated. It is then dried and wound up again at the other end.

These automatic devices are very expensive and require time (15 to 60 minutes) to clean.

### SUMMARY OF THE INVENTION

An object of the invention is to provide a manual method which avoids the deficiencies noted above in the existing systems.

A further object of the invention is to provide an apparatus which is easy to use and which will provide reliable coating layers of determined thickness uniformly on sheets of material of different sizes.

A further object of the invention is to provide apparatus which is simple to maintain and requires low maintenance costs and is relatively inexpensive to practice.

It is a particular object of the invention to provide a manual applicator device that can apply a smooth uniform coating to any size substrate and wherein the device has a replenishable reservoir which is easy to clean and assemble.

A further object of the invention is to provide a device which can be made in different sizes which will meet the needs of users depending on the width of the particular substrate.

The above and further objects of the invention are satisfied by an apparatus which comprises a tray adapted for containing a liquid coating, a wiper member adjacent to the tray, and a coating rod supported adjacent to the wiper element to pinch a substrate therebetween with a free leading end of the substrate extending from the rod and wiper element and a tail trailing end of the substrate immersed in the coating liquid in the tray so that when the free end of the substrate is pulled out of the tray, the wiper element wipes coating liquid from the back surface of the substrate while the coating rod leaves a layer of determined thickness of the coating liquid on the front surface of the substrate.

The invention also provides a method for applying a liquid coating on a surface of a substrate which comprises placing a substrate which is to be coated on one side thereof above a coating liquid contained in a reservoir in a tray, the substrate having a leading end extending on and beyond a wiper element at the front of the tray, pressing the substrate into the coating liquid in the reservoir while keeping the substrate on the wiper element and positioning a coating rod adjacent to the wiper element to pinch the substrate between the wiper element and the coating rod, pulling the substrate between the wiper element and the coating rod to form a coating of the coating liquid on one surface of the substrate facing the coating rod while the other surface of the substrate is wiped clean of liquid by the wiper element.

### BRIEF DESCRIPTION OF THE DRAWINGS

FIG. 1 is a diagrammatic side view of an apparatus according to the invention for applying a coating liquid on a flexible substrate.

FIG. 2 shows the apparatus in FIG. 1 with a cover thereof in raised position.

FIG. 3 is similar to FIG. 2 and shows a lid and a substrate placed on the lid.

FIG. 4 shows the apparatus of FIG. 3 after the lid has been removed.

FIG. 5 shows the apparatus of FIG. 4 with the cover closed.

FIG. 6 shows the apparatus of FIG. 5 in which the substrate has been partially pulled out of the apparatus.

FIG. 7 is an elevational view of a coating rod of the apparatus.

FIG. 8 is a rear perspective view of the apparatus.

FIG. 9 is a front perspective view of the apparatus.

FIG. 10 is an exploded front perspective view of another embodiment of the invention.

FIG. 11 diagrammatically illustrates a portion of the embodiment of FIG. 10 in engaged position.

FIG. 12 diagrammatically illustrates in side elevation the embodiment of FIG. 11 in a first stage of operation.

FIG. 13 diagrammatically illustrates in side elevation the embodiment of FIG. 11 in a second stage of operation.

FIG. 14 diagrammatically illustrates in side elevation the embodiment of FIG. 11 in a third stage of operation.

### DETAILED DESCRIPTION

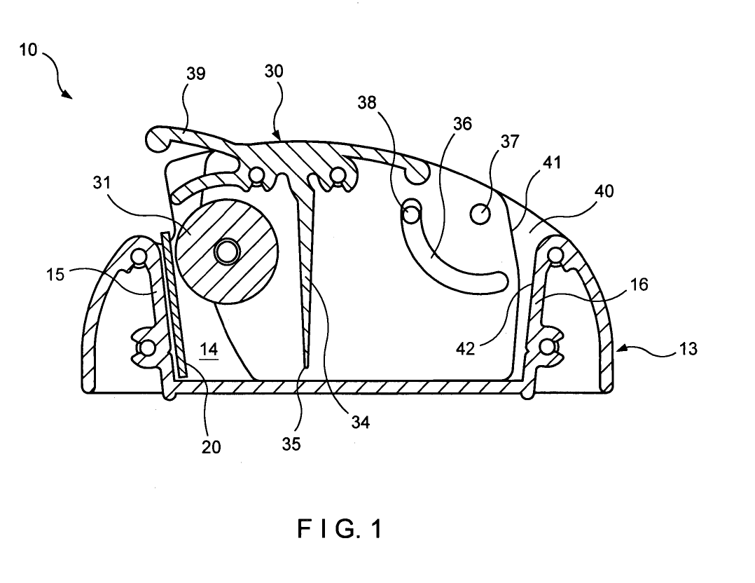

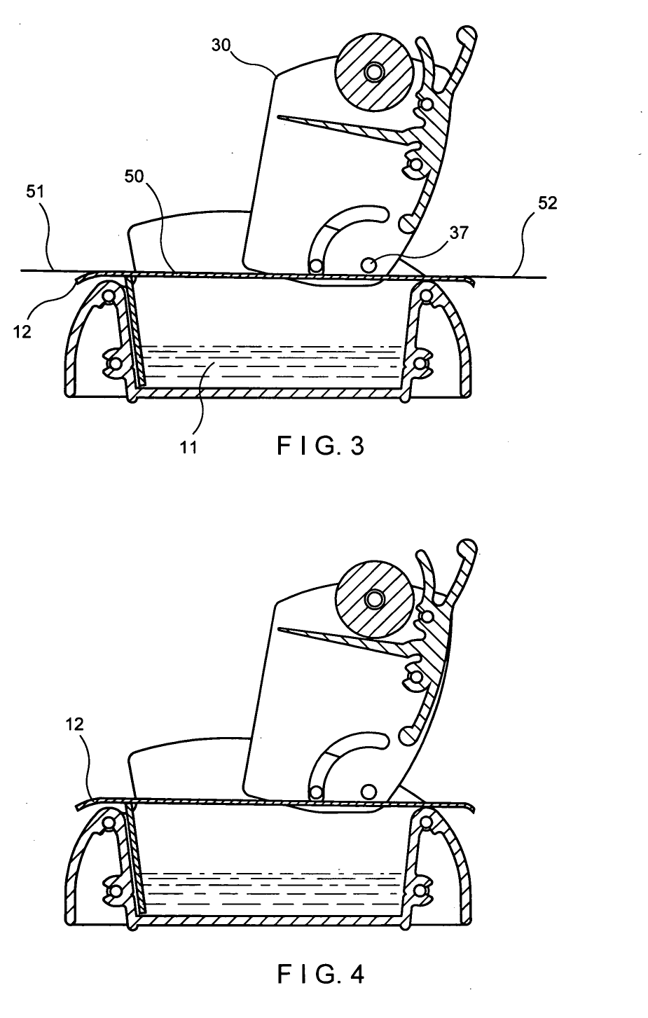

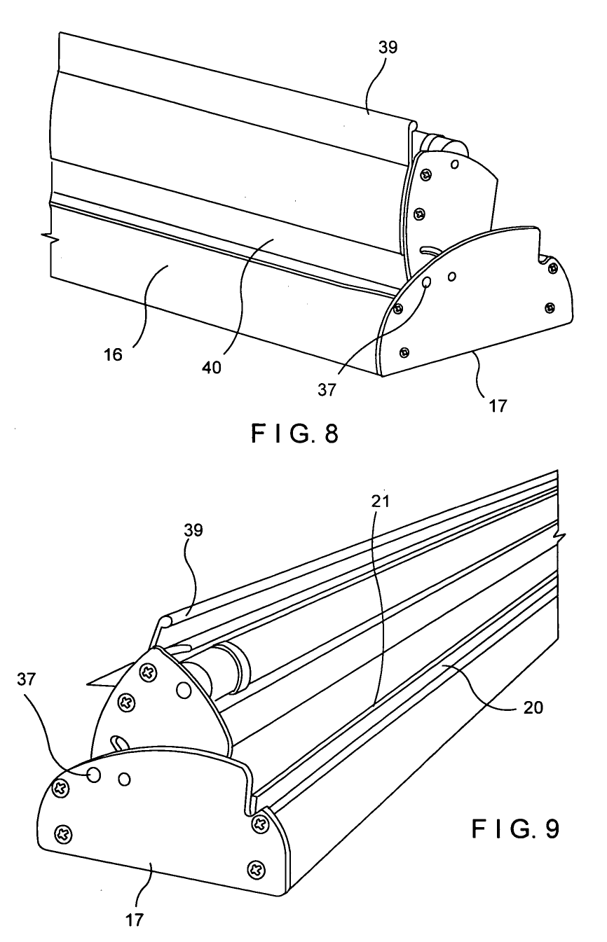

With reference to FIGS. 1-10 of the drawings, therein is shown a first embodiment of the invention comprising device 10 for applying a coating of a liquid 11 (FIG. 3) onto a substrate 12. The substrate 12 can be a flexible medium or sheet made of vinyl material, paper, and the like.

The device 10 is constructed to apply a uniform coating of the liquid smoothly and evenly onto one surface (upper surface) of the substrate 12 with a uniform thickness in a single pass of the substrate through the device 10 without any liquid on the opposite surface (bottom surface) of the substrate. The substrate 12 can be of various widths and the coating liquid is applied to the entire surface of the substrate to be coated. The coating liquid 11 can be a material which when dried on the substrate forms a protective coating for an image on the substrate. The coating liquid also can be an adhesive so that another sheet with an image thereon can be secured to the substrate. Preferably, the liquid 11 is in a conventional water based product.

The device 10 includes a tray 13 for the coating liquid 11 and the tray defines a reservoir 14 for the coating liquid 11. The tray 13 is formed with a front wall 15, a rear wall 16, opposite side panels 17 and a base 18. The walls 15, 16, side panels 17 and base 18 define an enclosure forming the reservoir 14.

At the front of the tray 11 adjacent to front wall 15, is a wiper element 20 made of silicone rubber. An upper edge 21 of the wiper element 20 extends slightly above the top of the front wall 15 for a purpose which will be explained in more detail later.

The tray 13 can be made of a metal or plastic material which is impervious to the coating liquid 11 to be employed. In a particular embodiment, the tray 13 is made as a lightweight aluminum extrusion

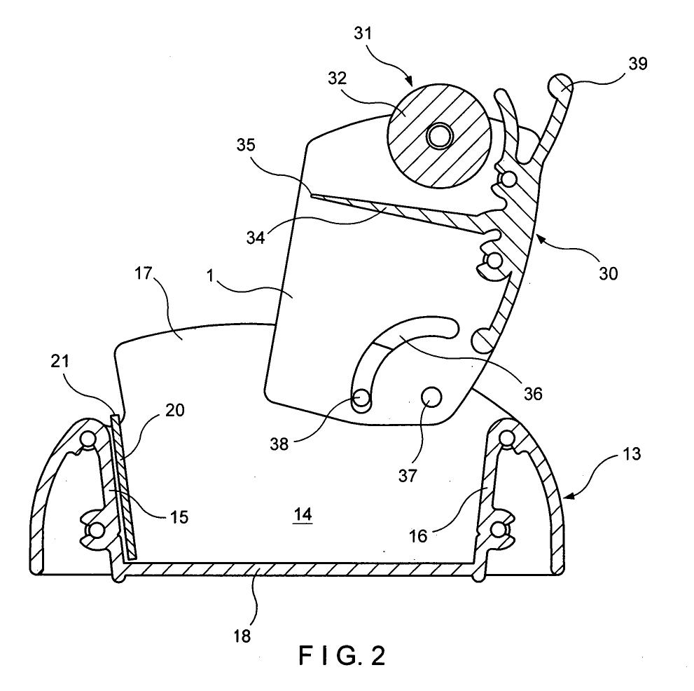

A cover 30 is joined to the side panels 17 so as to be movable from a raised position as shown in FIG. 2 to a lowered position as shown in FIG. 1. A coating rod 31 is secured to the cover 30 at the front of the cover and the coating rod 31 extends transversely across the entire length of the cover. The coating rod 31 projects forwardly of the cover 30 such that in the lowered position of the cover 30, the coating rod 31 is positioned adjacent to the wiper element 21 to pinch the substrate therebetween as will be explained more fully later. The coating rod 31 comprises a hollow shaft 32 of stainless steel on which a wire 33 is wound as shown in FIG. 7. The coating rod 31 is secured at its ends to the cover and during formation of coating liquid on the substrate by the coating rod 31, the coating rod remains stationary and the substrate slides on the surface of the coating rod. The coating rod 31 is supported by the cover 30 so that it can be turned and locked to present a different contact surfaces for subsequent substrates to be coated.

The cover 30 is also made as a lightweight aluminum extrusion and includes an integral, rigid blade 34 extending downwardly from the cover so that when the cover is closed, the blade 34 will extend into the reservoir 14 with the lower end 35 of the blade in close proximity to the base 18.

The cover 30 is provided with circular guide slots 36 at each of its opposite sides. The slots 36 are centered around pivot pins 37 which connect the cover 30 to the side panels 17 of the tray 13 for pivotal movement of the cover between the raised and lowered positions. A guide pin 38 is fixed to each of the side panels 17 of the tray and engage in the slots 36 to guide the cover in its pivotal movements between the raised and lowered positions. A handle 39 is located at the front of the cover 30 to enable the cover to be raised and lowered.

In order to apply a coating layer of uniform thickness onto the substrate 12, the following operation is carried out.

The reservoir 14 of tray 13 is filled with coating liquid through a passage 40 formed between a back surface 41 of the cover and a front surface 42 of the rear wall of the tray. The coating liquid can also be introduced into the open top of the tray when the cover is in its raised position.

When the cover 30 is in its raised position, a support plate or lid 50 of lightweight material, such as aluminum is placed on the tray 13, specifically on the wiper element 21 at the front and the top of the rear wall 13 at the back as shown in FIG. 3. The substrate 12, onto which the coating layer is to be applied, is then placed on the plate 50 which prevents the substrate from falling into the coating liquid. The substrate is positioned on the plate 50 such that a free leading end 51 of the substrate extends forwardly of the tray 13 as shown in FIG. 3. The rear or trailing end 52 of the substrate extends rearwardly of the plate 50 as shown in FIG. 3. With the substrate thus positioned on the plate 50, the plate is then removed in a forward direction to leave the substrate resting on the wiper element 20 and the rear wall 16 of the tray as shown in FIG. 4.

The substrate may be able to be positioned on the tray directly without the lid 50.

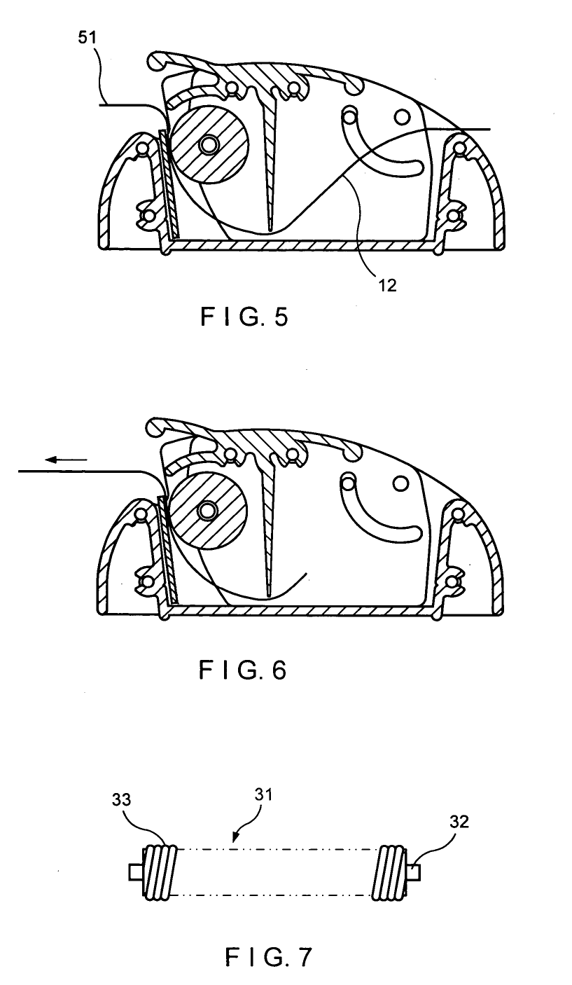

The front end of the substrate is then manually held by the user and handle 39 of the cover is then engaged to bring the cover 30 to its lowered position as shown in FIG. 5 whereupon the lower end 35 of the rigid blade 34 presses the substrate 12 down into the coating liquid 11 as shown in FIG. 5. Concurrently, the coating rod 21 is lowered with the cover to pinch the forward end of the substrate 12 between the coating rod 31 and the wiper element 21 leaving the end 51 of the substrate 12 free at the front of the tray 13.

By manually pulling the free end 51 of the substrate, the substrate will be pulled through the coating liquid in the tray and slid between the wiper element 21 and the coating rod 31 so that the back surface of the substrate will be wiped clean of coating liquid by the wiper element 21 while the coating rod 31 will apply a uniform layer of coating liquid 11 onto the top surface of the substrate 12. In this way, substrates of any width or length can be uniformly coated on one side thereof with the coating liquid. The thickness of the coating layer is governed by the diameter of the wire 33 wound on the coating rod. In this respect, coating rods with different diameter wire windings thereon can be selectively installed in the cover depending on the thickness of the coating layer to be applied onto the substrate.

The pivotal cover 30 represents one embodiment of means for moving the coating rod 21 between its operative and inoperative positions. Other embodiments are also contemplated within the scope of the invention.

A simpler embodiment of the invention for moving the coating rod between its operative and inoperative positions is described hereafter and the same or similar elements described in the earlier embodiment will have the same reference numerals with the suffix A applied thereto.

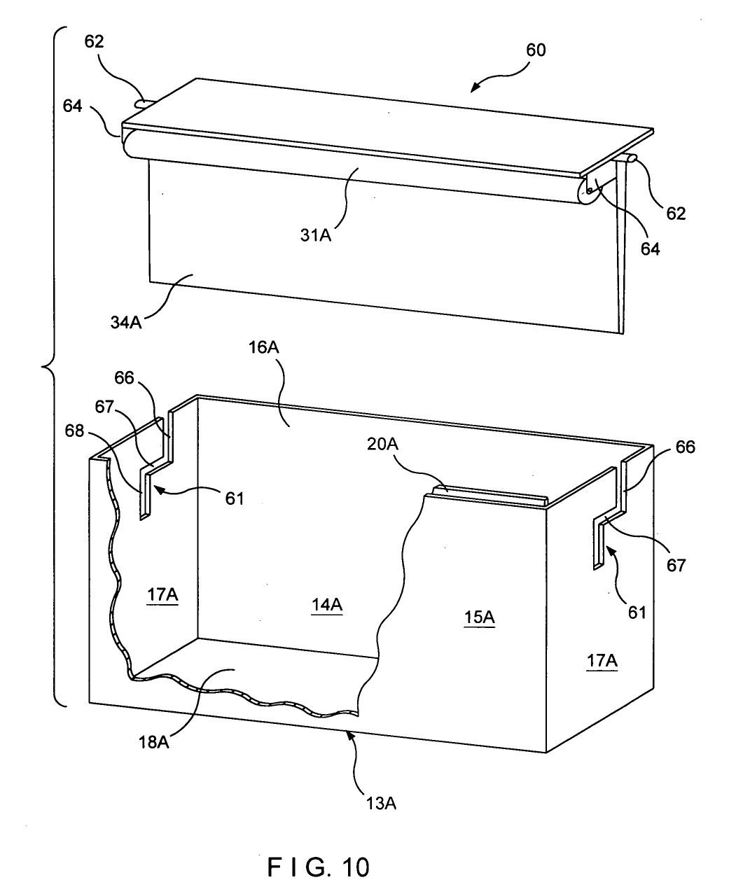

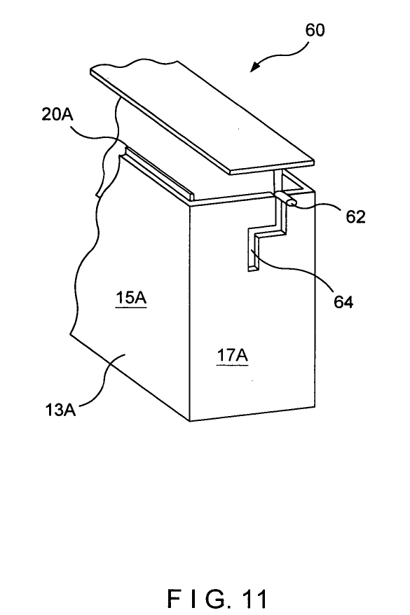

FIG. 10 shows a tray 13A and a T-shaped bar assembly 60 which replaces the cover 30 of the earlier described embodiment.

The tray 13A includes front wall 15A, rear wall 16A, side panels 17A and rear wall 18A. The tray 13A forms a reservoir 14A for coating liquid 11. A wiper element 20A is attached to the back of the front wall 15A and projects slightly thereabove. The side panels 17A are formed with Z-shaped notches 61 adapted to support stub shafts 62 at the sides of the T-bar assembly 60.

The T-bar assembly 60 serves a similar function as the cover 30 and is made as a molded plastic body. The T-bar assembly comprises a top plate 63 from which integral blade 34A projects downwardly. Coating rod 31A is secured to end brackets 64 of the T-bar assembly 60 and extends transversely across the entire width thereof.

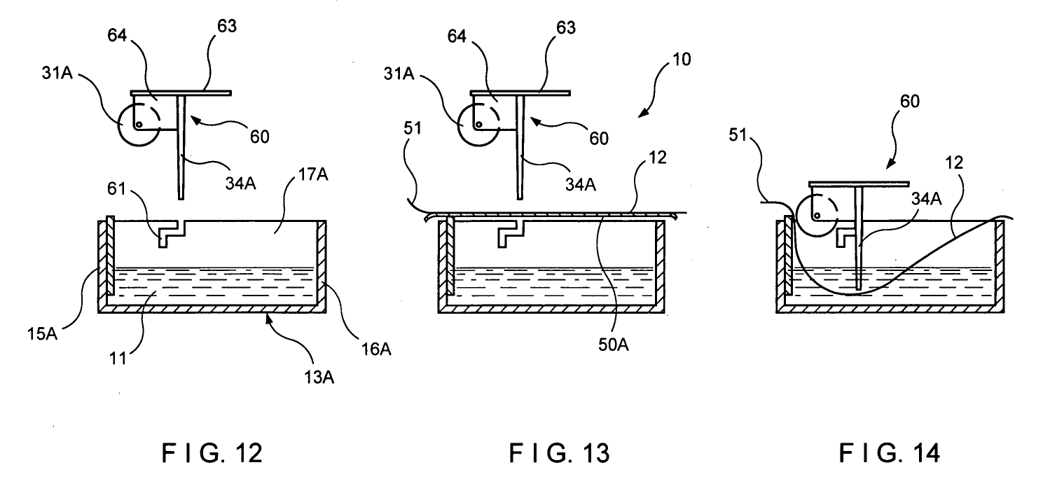

FIG. 12 shows the tray 13A after it has been filled with coating liquid 11. The T-bar assembly 60 is above the tray 13A.

FIG. 13 shows support plate 50A placed on the front and rear walls of the tray and the substrate 12A on the support plate 50A with the leading end 51 of the substrate extending forwardly of the front wall 15A.

The support plate 50A is then removed by being pulled forwardly from the tray 13A. The T-bar assembly 60 is then lowered so that stub shafts 62 engage in open tops of vertical legs 66 of notches 62. The blade 34A pushes the substrate 12 into the coating liquid 11 in the reservoir 14A. The T-bar assembly 60 is then advanced in horizontal legs 67 of notches 62 and into vertical legs 68. When the stub shafts 62 reach the bottom of the legs 68, the coating rod 31A will be positioned adjacent to wiper element 20A to pinch the substrate 12 therebetween. The substrate 12 is then pulled through the tray whereby coating liquid will be applied to the upper surface of the substrate while the lower surface is wiped clean as in the earlier described embodiment.

The invention is characterized by the tray adapted for containing the liquid coating, the wiper member supported adjacent to the tray and the coating rod adapted to be manually positioned adjacent to the wiper member to pinch the substrate between the coating rod and the wiper element. The free end of the substrate extends from the coating rod and the wiper element away from the tray such that when the free end of the substrate is manually pulled, the substrate will be progressively removed from the tray with a uniform layer of the coating liquid on the top surface of the substrate while the bottom surface of the substrate is wiped clean.

The invention is also characterized by the method in which all operations to coat the substrate are manually carried out and no connection to an electrical power supply is needed.

Although the invention is disclosed with reference to particular embodiments thereof, it will become apparent to those skilled in the art that numerous modifications and variations can be made which will fall within the scope and spirit of the invention as defined by the attached claims.

What is claimed is:

1. Apparatus for applying a liquid coating to one surface of a flexible substrate, said apparatus comprising:
a tray for containing a coating liquid,
a wiper member adjacent to said tray, and
a coating rod supported adjacent to said wiper element to pinch a substrate therebetween with a free end of the substrate extending from the rod and wiper element and a tail end of the substrate immersed in the coating liquid in the tray so that when the free end of the substrate is engaged to pull the rest of the substrate from the tray, the wiper element wipes the coating liquid from a back surface of the substrate while the coating rod forms a layer of determined thickness of the coating liquid on a front surface of the substrate.

2. The apparatus of claim 1, wherein said wiper member is secured to a front end of said tray, and said coating rod comprises a wire-wound rod.

3. The apparatus of claim 1, wherein said coating rod is supported for being moved between an operative position adjacent to said wiper element and an inoperative position away from said wiper element.

4. The apparatus of claim 3, comprising means associated with said coating rod to press the substrate into the coating liquid when the coating rod is moved to said operative position.

5. The apparatus of claim 4, comprising a removable support plate adapted for being supported on said tray in order to support and position the substrate thereon before the coating rod is moved to said operative position.

6. Apparatus for a applying liquid coating to one side of a flexible substrate comprising:
a tray for containing a coating liquid,
a cover pivotably connected to said tray for being moved between closed and open positions,
a fixed wiper member at one end of said tray extending upwardly and outside said cover when the cover is in said closed position,
said tray being open when said cover is in said open position so that a substrate to be coated can be placed on said tray with a front part of the substrate extending on and in front of said wiper member,
said substrate being immersed in the coating liquid when the cover is in closed position, and
a coating rod extending across said cover for being positioned adjacent to said wiper member when said cover is closed to engage the substrate between the wiper member and the coating rod with a front part of the substrate extending in front of the wiper member to enable the front part of the substrate to be engaged to pull the substrate from the tray between the wiper member and the coating rod and cause a layer of the coating liquid to be applied to a top surface of the substrate with a determined thickness while a bottom surface of the substrate is wiped clean by the wiper member.

7. The apparatus of claim 6, wherein said wiper member is made of silicone rubber.

8. The apparatus of claim 6, wherein said tray includes opposite side panels to which said cover is pivotably connected.

9. The apparatus of claim 8, wherein each side panel includes a guide pin and said cover includes guide slots each slidably receiving a respective said guide pin.

10. The apparatus of claim 6, comprising a projecting member integral with said cover to press the substrate into the coating liquid when the cover is closed.

11. The apparatus of claim 6, wherein said coating rod comprises a shaft and a wire wound on said shaft to establish the thickness of the layer of coating liquid applied to the substrate.

12. The apparatus of claim 11, wherein said wire has a determined diameter which establishes the thickness of the layer of coating liquid applied to the substrate.

13. The apparatus of claim 6, comprising a removable support plate adapted for being supported on said tray when the cover is in said open position to enable the substrate to be positioned on the support plate without falling into the coating liquid.

14. The apparatus of claim 6, comprising a filling channel for introducing coating liquid into the tray when the cover is in closed position, said filling channel being formed between the tray and the closed cover.

15. The apparatus of claim 6, wherein the coating liquid comprises an adhesive.

16. A method of applying a liquid coating on one surface of a flexible substrate, comprising the steps of:
placing a substrate which is to be coated on one side thereof, above a coating liquid contained in a reservoir in a tray, the substrate having a forward end extending on and beyond a wiper element at the front of the tray,
pressing the substrate into the coating liquid in the reservoir while keeping the substrate on the wiper element and while positioning a coating rod adjacent to the wiper element to pinch the substrate between the wiper element and the coating rod, and
pulling the substrate between the wiper element and the coating rod to form a coating of the coating liquid on one surface of the substrate facing the coating rod while the other surface of the substrate is wiped clean of coating liquid by said wiper element.

17. The method of claim 16, comprising pivotably connecting a cover to the tray for pivotal movement between open and closed positions and securing the coating rod to the cover so that when the cover is in closed position the coating rod is positioned adjacent to the wiper element.

18. The method of claim 16, comprising placing a removable support on the tray to support the substrate when the cover is in open position.

19. The method of claim 17, comprising forming a projecting blade on said cover to press the substrate into the coating liquid when the cover is in closed position.

20. The method of claim 16, wherein said wiper element is made of silicone rubber.

21. The method of claim 16, wherein the coating liquid includes an adhesive substance.

22. The method of claim 17, wherein the substrate is pulled on and over the wiper element as the substrate is pulled between the coating rod and the wiper element.

23. The method of claim 17, comprising forming a filling channel for the coating liquid between the tray and the cover when the cover is in closed position.

24. The method of claim 17, comprising establishing a thickness of the coating liquid on the substrate by providing a wire of determined diameter wound on said rod.
